(19) United States
(12) Patent Application Publication
(10) Pub. No.: US 2017/0121557 A1
(43) Pub. Date: May 4, 2017

(54) High-permeability epoxy waterproof material

(71) Applicant: Heeron Tech(Wuhan)New Materials Co.,Ltd., Wuhan (CN)

(72) Inventors: Wen Yan, Wuhan (CN); Silong Zheng, Wuhan (CN); Mulin Yan, Wuhan (CN); Li Xu, Wuhan (CN)

(73) Assignee: Heeron Tech(Wuhan)New Materials Co.,Ltd., Wuhan (CN)

(21) Appl. No.: 15/294,648

(22) Filed: Dec. 23, 2016

(30) Foreign Application Priority Data
Oct. 14, 2015 (CN) 201510665507.3

(51) Int. Cl. C09D 163/00; C09D 7/00

(52) U.S. Cl. CPC C09D 163/00; C09D 7/001

(57) ABSTRACT

A high-permeability epoxy waterproof coating material includes a first fluid and a second fluid. The first fluid by mass percentage includes 50-75% bisphenol A epoxy resin, 5-15% reactive diluent, 10-20% epoxy resin toughening agent, and 20-40% benzene diluent. The second fluid by mass percentage includes 15-20% polyether amine D2000, 10-15% D230, 50-70% diluent, 2-5% accelerant, and 20-30% benzene diluent. The first fluid is mixed with the second fluid to obtain the coating material. The coating material has strong permeability and good flexible, and is able to penetrate and repair surface cracks and pores of the concrete, for forming a layer of sealed integral waterproof structure on the concrete surface. Even if the surface film forming material is destroyed, the concrete surface is also closed by the coating, so as to form the dense waterproof structure, thereby achieving the permanent water proofing.

### CROSS REFERENCE OF RELATED APPLICATION

The present invention claims priority under 35 U.S.C. 119(a-d) to CN 201510665507.3, filed Oct. 14, 2015.

### BACKGROUND OF THE PRESENT INVENTION

Field of Invention

The present invention relates to a high-permeability epoxy waterproof coating material, which belongs to the technical field of coating material preparation.

Description of Related Arts

For concrete construction and road and bridge, concrete and steel is the most ideal combination. Although the steel is a kind of easily eroded material, if the surrounding environment is able to maintain a stable alkaline, the steel will not be eroded. Once the chloride ions, water, and acidic ions penetrate into the concrete, the PH value of the concrete is decreased from 11 to below 7, the steel of the concrete structure begins to be corroded. Waterproof performance is one of the most important factors affecting the life of concrete structure.

Traditional waterproof materials, such as emulsified asphalt and polyurethane, are able to form a layer of waterproof film on the concrete surface, which is able to play a good role in the concrete surface water proofing. Due to stress, the waterproof film on the concrete surface is easily damaged, so that the concrete structure will face the threat of corrosion again. Therefore, the high-performance and high durability of the waterproof materials will be the future market trend.

China Patent CN102504670A, published on Jun. 20, 2012 and named as “Permeability Epoxy Resin Waterproof Coating Material For Concrete”, provides a permeability epoxy resin waterproof coating material composition for concrete which comprises a component A and a component B with a weight percentage of A:B=(5-15):1, wherein: an ingredient of the component A by mass percentage comprises: 20-70% epoxy resin, 10-50% reactive diluent, and 10-40% epoxy modifying agent; an ingredient of the component B by mass percentage comprises: 10-90% curing agent, 1-20% accelerant, 1-10% enhancing penetrant. The main differences between the present invention and CN102504670A are as follows:

(1) The epoxy modifying agent is selected from the group consisting of butyl glycidyl ether, ethylene glycol diglycidyl ether, phenyl glycidyl ether and benzyl glycidyl ether.

(2) The curing agent is selected from the group consisting of ethylenediamine, diethylenetriamine, modified aliphatic amine and low molecular polyamide.

(3) The accelerant is selected from the group consisting of 2,4,6-tris (dimethylaminomethyl) phenol, triphenylphosphine and tetrabutyl titanate.

(4) The enhancing penetrant is a silane coupling agent.

China Patent CN102433057A, published on May 02, 2012 and named as “Two-component High-permeability Epoxy Resin Waterproof Reinforcement coating material and its preparation and application”, comprises a liquid A and a liquid B. An ingredient of the liquid A by mass percentage comprises: 45-75% epoxy resin, 15-30% reactive diluent, 50-75% oxo-compound, 2-8% plasticizer and 2-8% poly ethylene oxide surface active agent. An ingredient of the liquid B by mass percentage comprises: 10-20%polyamine, 2-7% intermediate active agent, 3-5% silane coupling agent, and 1-4.5% accelerant. The main differences between the present invention and CN102433057A are as follows:

(1) The reactive diluent is one or more members selected from a group consisting of butyl glycidyl ether, octyl glycidyl ether, 1,4-butanediol diglycidyl ether, ethylene glycol diglycidyl ether, 1,6-hexanediol Glycerol ether, neopentyl glycol diglycidyl ether, benzyl glycidyl ether, phenyl glycidyl ether and tolyl glycidyl ether.

(2) The polyamine is one or more members selected from a group consisting of ethylenediamine, butanediamine and hexamethylenediamine.

(3) The coupling agent is used.

The above two Chinese applications use polyamines and/or low molecular polyamides as epoxy resin curing agents. This series of curing agents have higher viscosity and rely on a large number of solvent dilution to reduce the viscosity and increase the permeability. The epoxy resin using this series of curing agents has unstable permeability, the initial penetration of the construction is good, but after the solvent is volatilized, the epoxy resin is prone to low strength and easy to be delaminated. At the same time, these curing agents have poor toughness after being solidified with epoxy resin, and the flexibility of the product is adjusted only by adding toughening agents; once the performance of the toughening agents is offset or the toughening agents are added improperly, after the product is solidified, aging and brittle rebound phenomenon are easy to occur, thereby resulting in damage to the waterproof layer.

### SUMMARY OF THE PRESENT INVENTION

An object of the present invention is to provide a high-permeability epoxy waterproof coating material with low viscosity, excellent flexibility, resistance to muggy and aging, long life and high strength.

Accordingly, in order to accomplish the above object, the present invention provides a high-permeability epoxy waterproof coating material, comprising: a first fluid and a second fluid, wherein:

an ingredient of the first fluid by mass percentage comprises:

| | |
|---|---|
| bisphenol A epoxy resin | 50-75%; |
| reactive diluent | 5-15%; |
| epoxy resin toughening agent | 10-20%; and |
| benzene diluent | 20-40%, |

an ingredient of the second fluid by mass percentage comprises:

| | |
|---|---|
| polyether amine curing agent | 25-35%; |
| benzene diluent | 20-30%; |
| accelerant | 2-5%; and |
| diluent | 50-70%. |

Preferably, the bisphenol A epoxy resin is E-51 epoxy resin.

Preferably, the reactive diluent is dimethylglycidyl ether, or tolyl glycidyl ether, or a mixture of dimethylglycidyl ether and tolyl glycidyl ether.

Preferably, the epoxy resin toughening agent is active toughening agent LD410 or GK-D410, or GK-D411.

Preferably, an ingredient of the benzene diluent by mass percentage comprises 30% xylene, 60% butanol, and 10% C9.

Preferably, the polyether amine curing agent is a mixture of diamine D2000 and D230, wherein: 40-70% D2000 and 30-60% D230 by mass percentage are mixed and stirred, and the polyether amine curing agent is obtained.

Preferably, the accelerant is KM or DMP-30.

Preferably, the diluent is nonyl phenol NP or NP-1.

By adopting the technical solution mentioned above, the present invention has advantages as follows.

The diamine D2000 and D230 are mixed to act as the epoxy resin curing agent. The curing agent has low viscosity, good compatibility with epoxy resin, long probation, high adhensive strength, excellent flexibility, and resistance to thermal shock, and is suitable to permeate into cracks and voids in concrete. Compared with conventional curing agents, the curing agent provided by the present invention has obvious advantages. Simultaneously, the curing agent provided by the present invention is able to adjust the structure of polyoxyalkylene and the reactivity of polyether amine. Due to special molecular structure, the excellently comprehensive performance of the polyether is endued to the curing agent provided by the present invention, so that the present invention has characteristics as follows.

The high-permeability epoxy waterproof coating material, provided by the present invention, has strong permeability and is able to penetrate and repair surface cracks and pores of the concrete, for forming a layer of sealed integral waterproof structure on the concrete surface. Even if the surface film forming material is destroyed, the concrete surface is also closed by the coating, so as to form the dense waterproof structure, thereby achieving the permanent water proofing.

1. The present invention has strong waterproof performance. The result of 90-day chloride penetration test is zero, which is 4320 times higher than the domestic 30-minute immersion test waterproof standard.

2. The present invention has a certain flexible, so that it is not easily broken.

3. The present invention is green and environmentally protective, non-toxic and non-polluting.

These and other objectives, features, and advantages of the present invention will become apparent from the following detailed description, the accompanying drawings, and the appended claims.

### DETAILED DESCRIPTION OF THE PREFERRED EMBODIMENT

The present invention is further explained with accompanying embodiments in detail.

A high-permeability epoxy waterproof coating material, comprising: a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises:

| | |
|---|---|
| bisphenol A epoxy resin | 50-75%; |
| reactive diluent | 5-15%; |
| epoxy resin toughening agent | 10-20%; and |
| benzene diluent | 20-40%; |

an ingredient of the second fluid by mass percentage comprises:

| | |
|---|---|
| polyether amine curing agent | 25-35%; |
| benzene diluent | 20-30%; |
| accelerant | 2-5%; and |
| diluent | 50-70%. |

Preferably, the bisphenol A epoxy resin is E-51 epoxy resin.

Preferably, the reactive diluent is dimethylglycidyl ether, or tolyl glycidyl ether, or a mixture of dimethylglycidyl ether and tolyl glycidyl ether.

Preferably, the epoxy resin toughening agent is active toughening agent LD410 or GK-D410, or GK-D411.

Preferably, an ingredient of the benzene diluent by mass percentage comprises 30% xylene, 60% butanol, and 10% C9.

Preferably, the polyether amine curing agent is a mixture of diamine D2000 and D230, wherein: 40-70% D2000 and 30-60% D230 by mass percentage are mixed and stirred, and the polyether amine curing agent is obtained.

Preferably, the accelerant is KM or DMP-30.

Preferably, the diluent is nonyl phenol NP or NP-1.

### Embodiment 1

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 50% epoxy resin E51, 15% dimethylglycidyl ether, 20% LD410, and 20% a mixture of 30% xylene, 60% butanol, and 10% C9;

an ingredient of the second fluid by mass percentage comprises: 10% polyether amine curing agent D2000, 15% polyether amine curing agent D230, 20% a mixture of 30% xylene, 60% butanol, and 10% C9, 2% accelerant K54 and 50% NP.

### Embodiment 2

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 75% epoxy resin E51, 5% dimethylglycidyl ether, 10% LD410, and 20% a mixture of 30% xylene, 60% butanol, and 10% C9;

an ingredient of the second fluid by mass percentage comprises: 20% polyether amine curing agent D2000, 15% polyether amine curing agent D230, 20% a mixture of 30% xylene, 60% butanol, and 10% C9, 5% accelerant K54 and 40% NP.

### Embodiment 3

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 60% epoxy resin E51, 10% dimethylglycidyl ether, 15% LD410, and 40% a mixture of 30% xylene, 60% butanol, and 10% C9;

an ingredient of the second fluid by mass percentage comprises: 15% polyether amine curing agent D2000, 15% polyether amine curing agent D230, 30% a mixture of 30% xylene, 60% butanol, and 10% C9, 3% accelerant K54 and 55% NP.

### Embodiment 4

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 57% epoxy resin E51, 12% dimethylglycidyl ether, 16% LD410, and 30% a mixture of 30% xylene, 60% butanol, and 10% C9;

an ingredient of the second fluid by mass percentage comprises: 17% polyether amine curing agent D2000, 10% polyether amine curing agent D230, 24% a mixture of 30% xylene, 60% butanol, and 10% C9, 4% accelerant K54 and 52% NP.

### Embodiment 5

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 65% epoxy resin E51, 14% dimethylglycidyl ether, 13% LD410, and 35% a mixture of 30% xylene, 60% butanol, and 10% C9;

an ingredient of the second fluid by mass percentage comprises: 8% polyether amine curing agent D2000, 17% polyether amine curing agent D230, 24% a mixture of 30% xylene, 60% butanol, and 10% C9, 1% accelerant K54 and 70% NP.

### Embodiment 6

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 60% epoxy resin E51, 20% dimethylglycidyl ether, 10% LD410, and 40% a mixture of 30% xylene, 60% butanol, and 10% C9;

an ingredient of the second fluid by mass percentage comprises: 15% polyether amine curing agent D2000, 20% polyether amine curing agent D230, 20% a mixture of 30% xylene, 60% butanol, and 10% C9, 3% accelerant K54 and 65% NP.

### Embodiment 7

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% LD410, and 28% a mixture of 30% xylene, 60% butanol, and 10% C9;

an ingredient of the second fluid by mass percentage comprises: 12% polyether amine curing agent D2000, 13% polyether amine curing agent D230, 25% a mixture of 30% xylene, 60% butanol, and 10% C9, 3% accelerant K54 and 60% NP.

### Embodiment 8

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% GK-D410, and 28% a mixture of 30% xylene, 60% butanol, and 10% C9;

an ingredient of the second fluid by mass percentage comprises: 12% polyether amine curing agent D2000, 13% polyether amine curing agent D230, 25% a mixture of 30% xylene, 60% butanol, and 10% C9, 3% accelerant K54 and 60% NP.

### Embodiment 9

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% GK-D410, and 28% a mixture of 30% xylene, 60% butanol, and 10% C9;

an ingredient of the second fluid by mass percentage comprises: 12% polyether amine curing agent D2000, 13% polyether amine curing agent D230, 25% a mixture of 30% xylene, 60% butanol, and 10% C9, 3% accelerant K54 and 60% NP.

### Embodiment 10

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% GK-D410, and 28% a mixture of 30% xylene, 60% butanol, and 10% C9;

an ingredient of the second fluid by mass percentage comprises: 12% polyether amine curing agent D2000, 13% polyether amine curing agent D230, 25% a mixture of 30% xylene, 60% butanol, and 10% C9, 3% accelerant K54 and 60% NP-1.

### Embodiment 11

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% GK-D411, and 28% a mixture of 30% xylene, 60% butanol, and 10% C9;

an ingredient of the second fluid by mass percentage comprises: 10% polyether amine curing agent D2000, 15% polyether amine curing agent D230, 25% a mixture of 30% xylene, 60% butanol, and 10% C9, 3% accelerant K54 and 60% NP-1.

### Embodiment 12

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 50% epoxy resin E51, 15% dimethylglycidyl ether, 20% GK-D411, and 20% a mixture of 30% xylene, 60% butanol, and 10% C9;

an ingredient of the second fluid by mass percentage comprises: 13% polyether amine curing agent D2000, 12% polyether amine curing agent D230, 20% a mixture of 30% xylene, 60% butanol, and 10% C9, 2% accelerant DMP-30 and 50% NP.

### Embodiment 13

A high-permeability epoxy waterproof coating material comprises a first fluid and a second fluid, wherein:

the coating material is formed by proportionally mixing the first fluid and the second fluid, and then stirring for 10-20 minutes at room temperature in a mixing tank;

an ingredient of the first fluid by mass percentage comprises: 70% epoxy resin E51, 7% dimethylglycidyl ether, 15% GK-D411, and 28% a mixture of 30% xylene, 60% butanol, and 10% C9;

an ingredient of the second fluid by mass percentage comprises: 11% polyether amine curing agent D2000, 14% polyether amine curing agent D230, 25% a mixture of 30% xylene, 60% butanol, and 10% C9, 3% accelerant DMP-30 and 60% NP-1.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A high-permeability epoxy waterproof coating material, comprising: a first fluid and a second fluid, wherein:
an ingredient of the first fluid by mass percentage comprises:

| | |
|---|---|
| bisphenol A epoxy resin | 50-75%; |
| reactive diluent | 5-15%; |
| epoxy resin toughening agent | 10-20%; and |
| benzene diluent | 20-40%; |

an ingredient of the second fluid by mass percentage comprises:

| | |
|---|---|
| polyether amine curing agent | 25-35%; |
| benzene diluent | 20-30%; |
| accelerant | 2-5%; and |
| diluent | 50-70%. |

2. The high-permeability epoxy waterproof coating material, as recited in claim 1, wherein: the bisphenol A epoxy resin is E-51 epoxy resin.

3. The high-permeability epoxy waterproof coating material, as recited in claim 1, wherein: the reactive diluent is dimethylglycidyl ether, or tolyl glycidyl ether, or a mixture of dimethylglycidyl ether and tolyl glycidyl ether.

4. The high-permeability epoxy waterproof coating material, as recited in claim 1, wherein: the epoxy resin toughening agent is active toughening agent LD410 or GK-D410, or GK-D411.

5. The high-permeability epoxy waterproof coating material, as recited in claim 1, wherein: an ingredient of the benzene diluent by mass percentage comprises 30% xylene, 60% butanol, and 10% C9.

6. The high-permeability epoxy waterproof coating material, as recited in claim 1, wherein: the polyether amine curing agent is a mixture of diamine D2000 and D230, wherein: 40-70% D2000 and 30-60% D230 by mass percentage are mixed and stirred, and the polyether amine curing agent is obtained.

7. The high-permeability epoxy waterproof coating material, as recited in claim 1, wherein: the accelerant is K54 or DMP-30.

8. The high-permeability epoxy waterproof coating material, as recited in claim 1, wherein: the diluent is nonyl phenol NP or NP-1.
